(19) United States
(12) Patent Application Publication
(10) Pub. No.: US 2016/0299597 A1
(43) Pub. Date: Oct. 13, 2016

(54) TOUCH SCREEN PANEL, DISPLAY DEVICE INCLUDING THE SAME, AND DRIVING METHOD THEREOF

(71) Applicant: Samsung Display Co., Ltd., Yongin-si (KR)

(72) Inventors: Young Seok YOO, Suwon-si (KR); Hyun Jae LEE, Seoul (KR)

(21) Appl. No.: 14/867,316

(22) Filed: Sep. 28, 2015

(30) Foreign Application Priority Data
Apr. 7, 2015 (KR) 10-2015-0049143

(51) Int. Cl. G06F 3/044

(52) U.S. Cl. CPC G06F 3/044

(57) ABSTRACT

A display device including a display panel configured to display an image, a touch sensing layer disposed above the display panel and the touch sensing layer including a touch substrate, a touch electrode disposed on the touch substrate, and a common touch electrode disposed under the touch substrate, a first driver configured to apply a sensing input voltage having a first phase to the touch electrode, and a second driver configured to apply a common input voltage having a second phase to the common touch electrode. The second phase of the common input voltage is different from the first phase the sensing input voltage.

### CROSS-REFERENCE TO RELATED APPLICATION

This application claims priority from and the benefit of Korean Patent Application No. 10-2015-0049143, filed on Apr. 7, 2015, which is hereby incorporated by reference for all purposes as if fully set forth herein.

### BACKGROUND

1. Field

Exemplary embodiments relate to a touch screen panel, a display device including the same, and driving method thereof.

2. Discussion of the Background

A display device such as a liquid crystal display (LCD), organic light emitting diode (OLED) display, and electrophoretic display generally includes a field generating electrode and an electro-optical active layer.

For example, an organic light emitting device includes an organic emission layer as the electro-optical active layer. The field generating electrode is connected to a switching element such as a thin film transistor and a data signal is applied to the field generating electrode. The electro-optical layer displays an image by converting the data signal into an optical signal.

Using a heavy and fragile glass substrate in a display device limits the device's portability and screen size (i.e., larger screens). As such, researchers are actively developing a flexible display device, which is not only lightweight and highly impact-resistant, but also uses a flexible plastic substrate as the substrate for a display panel.

Display devices may include a touch sensing function allowing a user to interact and provide inputs to the device.

The touch sensing function may determine contact information (i.e., determine whether an object approaches or contacts a screen and a contact position of the object contacting the screen) by sensing a change in pressure, charge, light, and the like that are applied on the screen of the display device when an object contacts the screen (i.e., a user writes text or draws a figure by approaching or contacting the screen with a finger or a stylus). The display device may receive an image signal based on the contact information in order to display a corresponding image. The display device may receive an image signal based on the contact information in order to display an image.

The touch sensing function may be implemented by a touch sensor. The touch sensor may be classified according to various touch sensing types such as a resistive type, a capacitive type, an electro-magnetic (EM) type, and an optical type.

The capacitive type touch sensor includes a sensing capacitor having sensing electrodes capable of transferring a sensing signal. The capacitive type touch sensor may determine whether there is a contact, a contact position, and the like by sensing a change in capacitance of the sensing capacitor or an amount of charge in the sensing capacitor generated when a conductor such as a finger approaches the touch sensor. The capacitance type touch sensor includes touch electrodes disposed at a contact sensing region and signal transfer wiring connected to the touch electrodes. The signal transfer wiring may transfer a sensing input signal to the touch electrode or a sensing output signal of the touch electrode generated by the touch to the sensing signal controller. The capacitive type touch sensor may be embedded in a separate touch screen panel and the touch screen panel may be attached above the display device to perform the touch sensing function. Consumers are demanding slimmer display devices having thinner touch screen panels. Thus, developers and manufacturers are trying to meet the consumer demand by developing and manufacturing thinner touch screen panels for the slimmer display devices. Unfortunately, the parasitic capacitance (Cp) (i.e., capacitance formed between the touch electrode of the touch screen panel and a cathode formed at the display panel of the display device) in thin touch screen panels is too high. Thus, the operation of the capacitive type touch sensor in thin touch screen panels is considerably affected and may cause the capacitive type touch sensor to not properly perform its charge and discharge operation if the parasitic capacitance exceeds a limit.

The above information disclosed in this Background section is only for enhancement of understanding of the background of the inventive concept, and, therefore, it may contain information that does not form the prior art that is already known in this country to a person of ordinary skill in the art.

### SUMMARY OF THE INVENTION

Exemplary embodiments provide a thin touch screen panel having a reduced parasitic capacitance.

Further, exemplary embodiments provide a display device including a thin touch screen panel having a reduced parasitic capacitance and method of driving the display device including the thin touch screen panel having a reduced parasitic capacitance.

Additional aspects will be set forth in the detailed description which follows, and, in part, will be apparent from the disclosure, or may be learned by practice of the inventive concept.

An exemplary embodiment discloses a display device including a display panel configured to display an image, a touch sensing layer disposed above the display panel and the touch sensing layer including a touch substrate, a touch electrode disposed on the touch substrate, and a common touch electrode disposed under the touch substrate, a first driver configured to apply a sensing input voltage having a first phase to the touch electrode, and a second driver configured to apply a common input voltage having a second phase to the common touch electrode. The second phase of the common input voltage is different from the first phase the sensing input voltage.

An exemplary embodiment also discloses a touch screen panel including a touch substrate, a touch electrode disposed on the touch substrate and configured to receive a sensing input voltage, and a common touch electrode disposed under the touch substrate and configured to receive a common input voltage having a phase opposite of the sensing input voltage received by the touch electrode.

An exemplary embodiment further discloses a method for driving a display device, the method including applying a first voltage to a touch electrode of the display device to detect a touch to a touch screen panel of the display device and applying a second voltage having a phase opposite of the first voltage to a common touch electrode of the display device.

According to an exemplary embodiment, the value of the parasitic capacitance may be reduced by applying a voltage to the common touch electrode having a phase opposite of a sensing input voltage applied to the touch electrode.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram of display device including a touch screen panel according to an exemplary embodiment.

FIG. 2 is a top plan view of a touch sensor of a touch screen panel according to an exemplary embodiment.

FIG. 3 is a perspective view of a display device including a touch screen panel according to an exemplary embodiment.

FIG. 4 is an enlarged view of a portion of the touch sensor illustrated in FIG. 2.

FIG. 5 is a cross-sectional view of the touch sensor illustrated in FIG. 4 taken along a section line A-A′.

FIG. 6 is a representation of a method for driving a touch sensing layer according to an exemplary embodiment.

FIG. 7 is a graph illustrating a voltage applied to a touch sensing layer.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

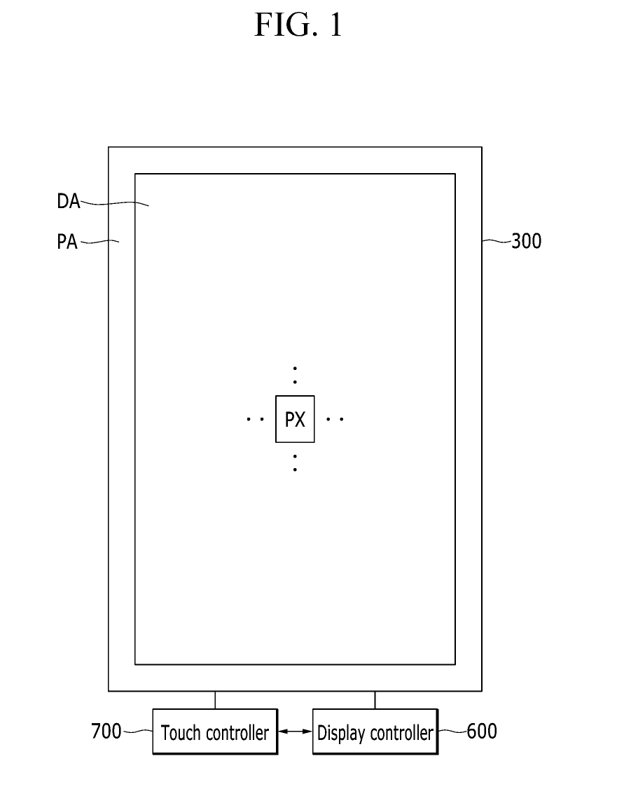

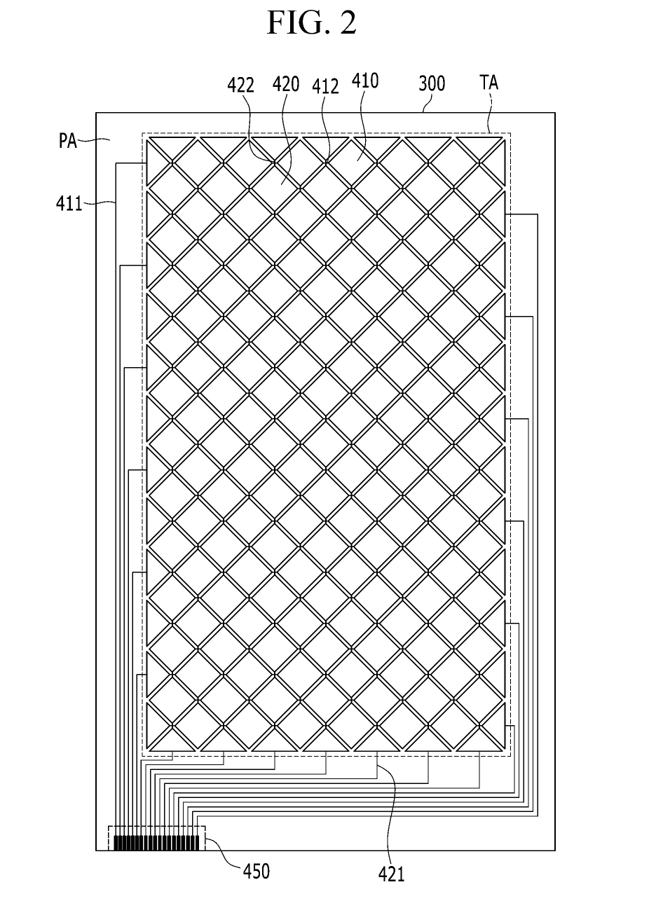

FIG. 1 is a block diagram of display device including a touch screen panel according to an exemplary embodiment. FIG. 2 is a top plan view of a touch sensor of a touch screen panel according to an exemplary embodiment.

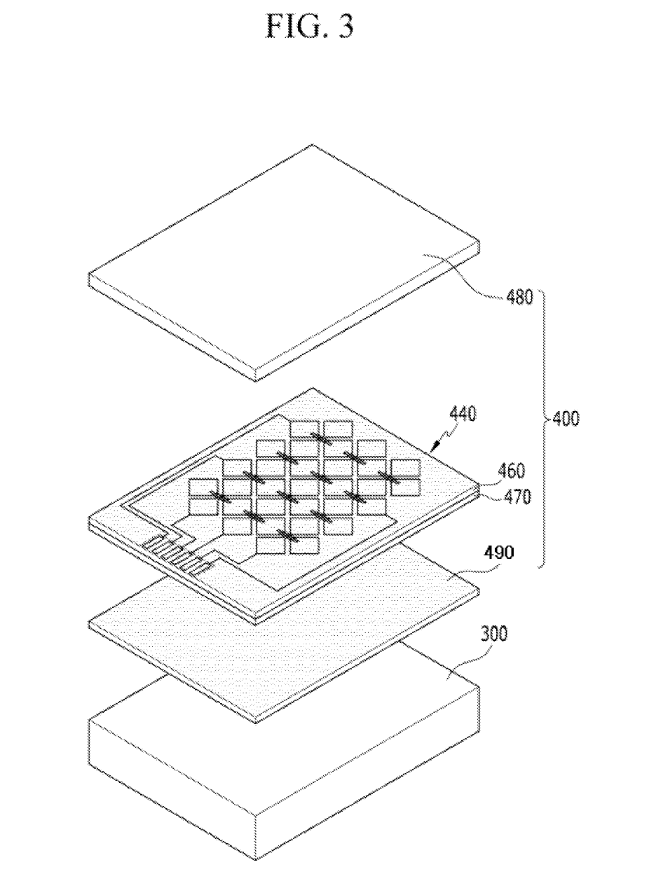

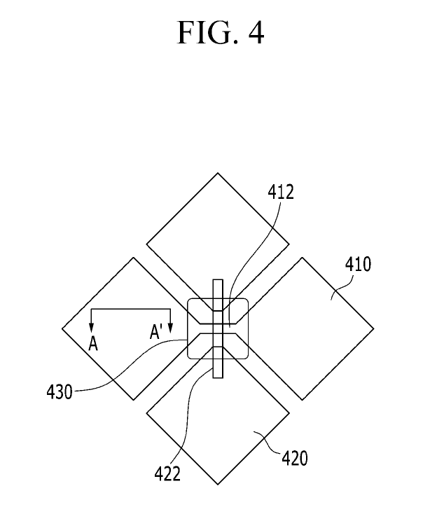

FIG. 3 is a perspective view of a display device including a touch screen panel according to an exemplary embodiment. FIG. 4 is an enlarged view of a portion of the touch sensor illustrated in FIG. 2.

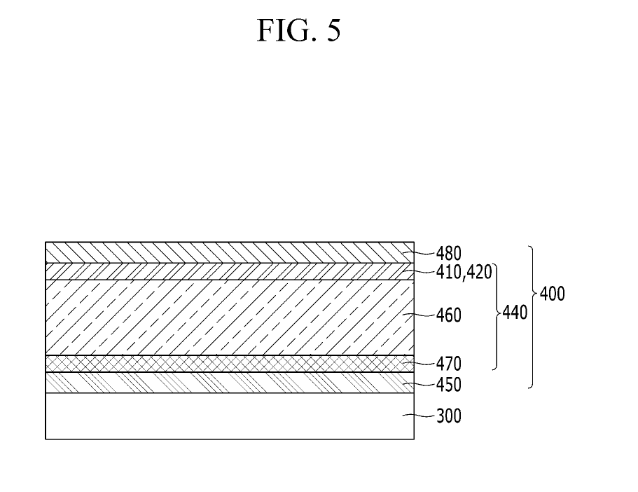

FIG. 5 is a cross-sectional view of the touch sensor illustrated in FIG. 4 taken along a sectional line A-A′.

Referring to FIG. 1, the display device including a touch screen panel according to an exemplary embodiment includes a display panel 300, a display controller and a touch controller 700 connected to the display panel 300.

The display panel 300 may display an image and detect a touch from an object (e.g., a touch pen, stylus, or a user's finger). The display panel 300, when viewed as a planar structure, includes a display area DA displaying an image and a peripheral area PA at a periphery of the display area DA.

A portion of a region or an entire region of the display panel 300 may be a touch active area TA which can detect a touch (FIG. 2). The touch active area TA may be a region which detects a touch when an object approaches or contacts the display panel 300

Contact includes not only an external object (i.e., a user's finger directly touching the display panel 300), but also the external object approaching the display panel 300 or hovering over the display panel 300 while at the approached state.

FIG. 2 illustrates approximately the entire display area DA being the touch active area TA but exemplary embodiments are not so limited. A portion of the peripheral area PA may be used as the touch active area TA or only a portion of the display area DA may make up the touch active area TA.

Referring to FIG. 1, pixels PX and display signal lines (not shown) that connect to the pixels PX to transmit a driving signal are arranged in the display area DA.

The display signal line may include scanning signal lines (not shown) transmitting a scanning signal and data lines (not shown) transmitting a data signal. The scanning signal lines and data lines extend while intersecting with each other. The scanning signal lines and data lines may extend up to the peripheral area PA and form a pad unit (not shown).

The pixel PX may be arranged in a matrix shape but exemplary embodiments are not so limited. Instead, pixels may be arranged in any shape.

Each pixel PX may include a switching element (not shown) connected to a gate line and the data line. A pixel electrode (not shown) may also be connected to the switching element. The switching element may be a three terminal element such as a thin film transistor integrated on the display panel 300. The switching element may selectively transmit the data signal through the data line to the pixel electrode by turn-on and turn-off operation. The pixel PX may further include an opposed electrode (not shown) opposing the pixel electrode. For an organic light emitting device, a light emission layer may be interposed between the pixel electrode and the opposed electrode and thereby forming a light emitting device. The opposed electrode may be applied with a common voltage.

In order to implement a color display, each pixel may display a primary color. A desired color is composed by a combination of the primary colors. Examples of primary colors may be three primary colors (i.e., red, green, and blue) or four primary colors (i.e., the three primary colors and white). Each pixel PX is situated at a corresponding position to each pixel electrode. Each pixel PX may further include a color filter exhibiting one of the three or four primary colors or the emission layer included in the light emitting device may emit a colored light.

A touch sensor is disposed at the touch active area TA. The touch sensor may detect contact by various methods. For example, the touch sensor may be a resistive type, a capacitive type, an electro-magnetic (EM) type or an optical type.

The present exemplary embodiment is embodied as the capacitive type touch sensor. However, other touch sensors type may be used.

Referring to FIG. 2, the touch sensor according to an exemplary embodiment may include touch electrodes. The touch electrodes may include first touch electrodes 410 and second touch electrodes 420. The first touch electrode 410 and the second touch electrode 420 are separated from each other.

Referring to FIG. 2, the first touch electrodes 410 and the second touch electrodes 420 may be alternatingly disposed in the touch active area TA without overlapping each other. The first touch electrodes 410 may be disposed in a column direction and a row direction and the second touch electrodes 420 may also be disposed in a column direction and a row direction.

The first touch electrodes 410 and the second touch electrodes 420 may be disposed as a same layer.

The first touch electrodes 410 and the second touch electrodes 420 may each have a shape of quadrangle. However, exemplary embodiments are not so limited because the first touch electrodes 410 and the second touch electrodes 420 may have any shape. The first touch electrodes 410 and the second touch electrodes 420 may have a protrusion in order to enhance sensitivity of the touch sensor.

The first electrodes 410 arranged at the same row or column can either be connected or separated at an interior or exterior of the touch active area TA. Similarly, at least a portion of the second touch electrodes 420 arranged at the same column or row can either be connected or separated at the interior or exterior of the touch active area TA. For example, as shown in FIGS. 2, 3, and 4 the first touch electrodes 410 disposed in the same row may be connected to each other at the interior of the touch active area (TA) while the second touch electrodes 420 disposed in the same column may also be connected to each other at the interior of the touch active area TA.

More specifically, the first touch electrodes 410 disposed in each row may be connected to each other by a plurality of first connectors 412, and the plurality of second touch electrode may be connected to each other by a plurality of second connectors 422.

As shown in FIG. 3, a common touch electrode 470 is disposed to cover the entire region of the display panel 300. The common touch electrode 470 will be described later with reference to FIGS. 4 and 5.

Referring back to FIG. 2, the first touch electrodes 410 connected to each other at each row may include a first touch electrode 410 at the end of the row that connects to a touch controller 700 through a first touch wiring 411. The second touch electrodes 420 connected to each other at each column may include a second touch electrode 420 at end of the column that connects to the touch controller 700 through a second touch wiring 421. The first touch wiring 411 and the second touch wiring 421 may be disposed at the peripheral area PA of the display panel 300, but otherwise may be disposed at the touch active are TA.

An end part of the first touch wiring 411 and the second touch wiring 421 forms a pad unit 450 at the peripheral area PA of the display panel 300.

The first touch electrode 410 and the second touch electrode 420 may have a transmittance that is more than or equal to a predetermined transmittance so that light from the display panel 300 can transmit. For example, the first touch electrode 410 and the second touch electrode 420 may be made of transparent conductive material such as indium tin oxide (ITO), indium zinc oxide (IZO), a thin metal layer like silver nanowire (AgNW), a metal mesh and carbon nanotube (CNT). However, the transparent conductive material of the first touch electrode 410 and the second touch electrode 420 is not limited to such materials and may include any suitable material.

The first touch wiring 411 and the second touch wiring 421 may include a transparent conductive material of the first touch electrode 410 and the second touch electrode 420 or a low resistance material such as molybdenum (Mo), silver (Ag), titanium (Ti), copper (Cu), aluminum (Al), and molybdenum/aluminum/molybdenum(Mo/Al/Mo)

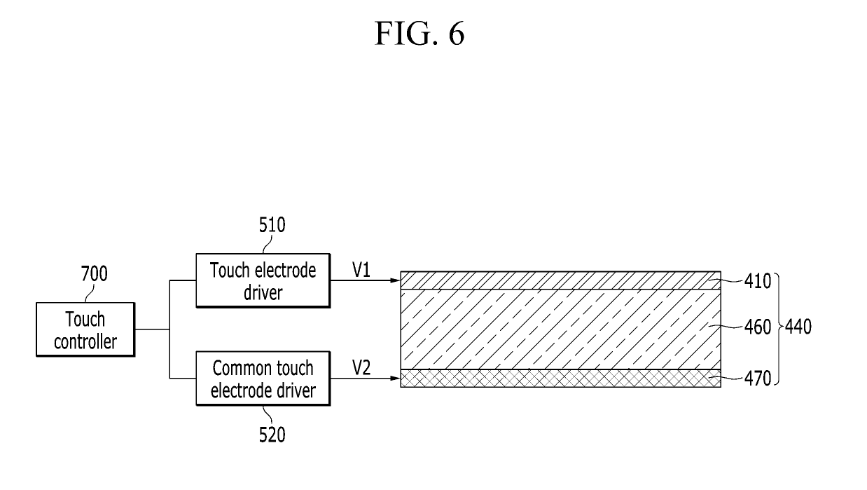

Neighboring first touch electrode 410 and second touch electrode 420 may form a mutual sensing capacitor that functions as the touch sensor. The mutual sensing capacitor may receive a sensing input signal through one of the first touch electrode 410 and the second touch electrode 420. The mutual sensing capacitor may output a change in charge amount resulting from the contact by an external object as a sensing output signal through the other of the first touch electrode 410 and the second touch electrode 420. For example, if the mutual sensing capacitor receives a sensing input signal through the first touch electrode 410 and a corresponding contact by an external object occurs, the mutual sensing capacitor may transmit a sensing output signal through the second touch electrode 420. As described in FIG. 6, a touch electrode driver 510 may apply a sensing input voltage corresponding to the sensing input signal to the first touch electrode 410 or the second touch electrode 420.

Unlike as shown in FIG. 2 and FIG. 4, the first touch electrodes 410 and the second touch electrodes 420 may be separated from each other and each may be connected to the touch controller 700 through a touch wiring (not shown). In such an instance, each touch electrode functioning as the touch sensor may form a self-sensing capacitor. The self-sensing capacitor may receive the sensing input signal and be charged by a small amount of charge. When the touch screen is contacted by external object (i.e., a finger), there is a change in an amount of charge and the self-sensing capacitor may output the sensing output signal different than the sensing input signal.

Again referring to FIG. 1, a display controller 600 controls image display operation of the display panel 300.

More specifically, the display controller 600 may receive an input image signal that carries luminance information of each pixel PX and an input control signal controlling the display of each pixel PX from an external device. The display controller 600 may convert the input image signal to an output image signal and generates a control signal (i.e., a gate control signal and a data control signal) by processing the input image signal and the input control signal. The display controller 600 may transmit the gate control signal to a gate driver (not shown) and the data control signal and the output image signal to a data driver (not shown).

Although not shown, the data driver may receive the output image signal for the pixel PX of one row according to the data control signal and may convert the output image signal to a data voltage by selecting a gray voltage corresponding to each output image signal. The data driver may apply the data voltage to a corresponding data line. The gate driver may apply a gate-on voltage according to the gate control signal to the gate line and turns on the switching element connected to the gate line. Then, the data voltage applied to the data line is applied to the corresponding pixel PX through the turned on switching element. When the data voltage is applied to the pixel PX, the pixel PX may display luminance corresponding to the data voltage by various optical conversion devices such as a light emitting device.

The touch controller 700 may be connected to the touch sensor disposed at the touch active area and may control the operation of the touch sensor. The touch controller 700 may transfer the sensing input signal to the touch sensor and may receive the sensing output signal. The touch controller 700 may process the sensing output signal and generate touch information (i.e., whether there is a touch or location of the touch). As described by FIG. 6, the touch controller 700 may transmit the sensing input signal to the touch electrode driver 510. The touch electrode driver 510 may respond to the sensing input signal by applying the sensing input voltage V1 to the first touch electrode 410 or the second touch electrode 420. Furthermore, the touch controller 700 may transmit a common input signal to a common touch electrode driver 520. In response, the common touch electrode driver 520 may apply a common input voltage V2 corresponding to the common input signal to the common touch electrode 470.

The data driver, gate driver, and display controller 600 may be mounted directly on the display panel 300 as at least one integrated circuit (IC) chip, mounted on a flexible printed circuit film (not shown), and attached to the display panel as a TCP (tape carrier package). Alternatively, the data driver, gate driver, and display controller 600 may be mounted on a separate printed circuit board (PCB) (not shown). On the other hand, the data driver and the gate driver may be integrated on the display panel 300 along with the display signal line and the switching element.

The touch electrode driver 510, the common touch electrode driver 520, and the touch controller 700 may also be mounted directly on the display panel 300 as at least one IC chip, mounted on a flexible printed circuit film (not shown), and attached to the display panel as a TCP. Alternatively, the touch electrode driver 510, the common touch electrode driver 520, and the touch controller 700 may be mounted on a separate printed circuit board (PCB). The touch controller 700 may be connected to the first touch wiring 411 and the second touch wiring 421 through the touch electrode driver 510, the common touch electrode driver 520, and the pad unit 450 of the display panel 300.

The display panel 300 may include a transparent insulation substrate including glass, quartz, ceramic, and plastic as a base.

Referring to FIG. 3, a touch sensing layer 440 can be stacked on the display panel 300 with an adhesive layer 490 interposed between the touch sensing layer 440 and the display panel 300. The touch sensing layer 440 may include touch electrodes and touch wirings that are formed by depositing a conductive material suitable for touch electrodes and touch wirings on a touch substrate by a sputtering method. Subsequently, the deposited conductive material is patterned or printed. Furthermore, the touch sensing layer 440 may include the common touch electrode deposited under the touch substrate by a sputtering method.

A touch screen panel 400 may include the touch sensing layer 440 having the touch sensor formed on the touch sensing layer 440. A polarizer 480 may be disposed to face the touch sensing layer 440 and the adhesive layer 490 may be disposed on the display panel 300.

The adhesive layer 490 may include a transparent adhesive material having a high light transmittance (i.e., a super view resin (SVR) or an optical cleared adhesive (OCA) film.

The polarizer 480 may enhance the display device's display of the color black of the by blocking reflected light from the touch electrodes 410, 420 and touch wiring. The polarizer 480 may include two sheet of at least one of a cyclo olefin polymer (COP), λ/2 phase retardation film, a λ/4 phase retardation film, and a polarization film.

Furthermore, the polarizer 480 may be an OLED polarizer applicable to a flexible substrate.

According to an exemplary embodiment, a touch sensing layer substrate 460 includes various plastics, metal thin films, or ultrathin glasses. The touch sensing layer substrate 460 may include at least one plastic film. The plastic film may include, for example, polyethylene terephthalate (PET), polyethylene naphthalate (PEN), polyimide (PI), polycarbonate (PC), polymethyl methacrylate (PMMA), polyarylate (PAR), poly ether imide (PEI), poly ether sulfone (PES), or cellulose triacetate (TAC).

Referring to FIG. 5, a touch electrode layer 410, 420 is formed on the touch sensing layer substrate 460. The touch electrode layer includes first touch electrodes 410 and second touch electrodes 420 that are alternately disposed without overlapping each other.

Referring to FIG. 4, the first touch electrodes 410 located at each row are connected to each other through the first connector 412 and the second electrodes 420 are connected to each other through the second connector 422.

There may be an insulating layer 430 disposed between the first connector 412 and the second connector 422 insulating the first connector 412 from the second connector 422. The insulating layer 430 may be multiple independent island-shaped insulators each positioned at each intersection of the first connector 412 and the second connector 422. The insulating layer 430 may expose at least a portion of the first touch electrode 410 so that the first connector 412 can be connected to the first touch electrode 410.

The first connector 412 connecting the first touch electrodes 410 adjacent to each other may be disposed as the same layer with the first touch electrode 410. The first connector 412 and the first touch electrodes 410 adjacent to each other may be formed of the same material. In other words, the first touch electrode 410 and the first connector 412 may be integrally formed and simultaneously patterned.

The second connector 422 connecting the second electrodes 420 adjacent to each other may be formed as a different layer than the second electrode 420. In other words, the second touch electrode 420 and the second connector 422 may be separate from each other and separately patterned. The second touch electrode 420 and the second connector 422 may be directly connected to each other.

Referring to FIG. 5, the common touch electrode 470 may be formed under the touch sensing layer substrate 460. The common touch electrode 470 may have a substantially planar shape to cover all of the first and second touch electrodes 410, 420. The common touch electrode 470 may be the same size as the touch sensing layer substrate 460. The shape of the common touch electrode 470 may be similar to the first and second touch electrodes 410, 420.

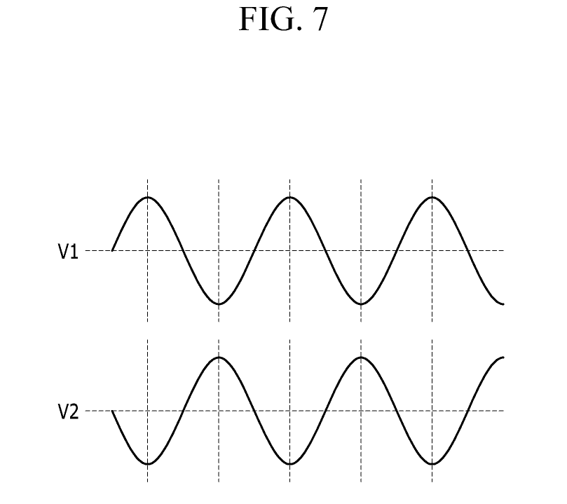

The common touch electrode 470 may be a separately formed electrode layer to decrease a value of the parasitic capacitance Cp formed between the touch electrode layer 410, 420 and the display panel 300. As illustrated in FIGS. 6 and 7, the common input voltage V2 having a phase opposite to that of the sensing input voltage V1 may be applied to the common touch electrode 470 to reduce the value of the parasitic capacitance Cp.

The common touch electrode 470 may have a transmittance that is more than or equal to a predetermined transmittance so that light from the display panel 300 can transmit. For example, the common touch electrode 470 may include transparent conductive materials such as indium tin oxide (ITO), indium zinc oxide (IZO), a thin metal layer like silver nanowire (AgNW), a metal mesh and carbon nanotube (CNT). However, the transparent conductive material of the common touch electrode 470 is not limited such materials. Instead, the common touch electrode 470 may include any suitable material.

In the touch screen panel 400 according to an exemplary embodiment, the polarizer 480 is not interposed between the adhesive layer 490 and the display panel 300. Instead the polarizer 480 is disposed above the touch electrode layer 410, 420. Therefore, the distance between the touch electrode layer 410, 420 and the display panel 300 may be reduced. As such, the value of parasitic capacitance Cp formed between the touch electrode layer 410, 420 and the display panel 300 is increased. When the value of the parasitic capacitance exceeds a limit, the touch screen 400 may not work properly.

A method of reducing the parasitic capacitance Cp will be described with reference to FIGS. 6 and 7.

FIG. 6 is a block diagram of touch panel including the touch sensing layer 440 according to an exemplary embodiment of the present invention. FIG. 7 is a graph illustrating voltages applied to the touch sensing layer 440. For convenience, the touch sensing layer 440 is illustrated to correspond to the entire touch screen panel 400 in FIG. 5.

Referring to FIG. 6, the touch controller 700 may transmit the sensing input signal to the touch electrode driver 510. The touch electrode driver 510 may apply the sensing input voltage V1 to the first touch electrode 410 in response receiving the sensing input signal. As shown in FIG. 7, the sensing input voltage V1 may be a sine wave. Alternatively, the sensing input voltage V1 may be a square wave rather than a sine wave.

Moreover, the touch controller 700 may transmit the common input signal to the common touch electrode driver 520. The common touch electrode driver 520 may apply the common input voltage V2 to the common touch electrode 470 in response to receiving common input signal. As shown in FIG. 7, the phase of the common input voltage V2 is different from the phase of the sensing input voltage V1 by about 180 degrees.

When the phase of the common input voltage V2 is different from the phase of the sensing input voltage V1 by about 180 degrees, the parasitic capacitance Cp decreases. When an alternative current (AC) power (i.e., current with polarity continuously changing between positive(+) and negative(−)) is applied to both electrodes of a capacitor with a phase difference of about 180 degrees, a capacitance formed between another electrode and the two electrodes of the capacitor decreases. In other words, the parasitic capacitance formed between the display panel 300 and the touch electrodes 410 and 470 decreases as a result of the common input voltage V2 and the sensing input voltage V1 (i.e., sensing input voltage V1 having polarities that continuously change between positive(+) and negative(−)) have phases that are different by about 180 degrees.

According to an exemplary embodiment, the value of the parasitic capacitance may be decreased by applying a voltage to the common touch electrode having a phase opposite of the sensing input voltage applied to the touch electrode. With a lower parasitic capacitance, touch screen panels may be thinner without resulting in an inoperative device. Instead, a thin display device may be implemented.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display device, comprising:
a display panel configured to display an image;
a touch sensing layer disposed above the display panel and the touch sensing layer comprising a touch substrate, a touch electrode disposed on the touch substrate, and a common touch electrode disposed under the touch substrate;
a first driver configured to apply a sensing input voltage having a first phase to the touch electrode; and
a second driver configured to apply a common input voltage having a second phase to the common touch electrode, wherein the second phase of the common input voltage is different from the first phase the sensing input voltage.

2. The display device of claim 1, wherein the second phase of common input voltage is different from the phase of the sensing input voltage by about 180 degrees.

3. The display device of claim 1, further comprising:
an adhesive layer interposed between the common touch electrode and the display panel.

4. The display device of claim 1, further comprising:
a polarizer disposed on the touch sensing layer.

5. The display device of claim 4, wherein the polarizer is configured to block light reflected by the touch electrode to enhance display of black color.

6. The display device of claim 1, further comprising:
a touch controller configured to transmit a sensing input signal corresponding to the sensing input voltage to the first driver and a common input signal corresponding to the common input voltage to the second driver.

7. The display device of claim 1, wherein a value of a parasitic capacitance generated between the touch electrode and the display panel is reduced by the common input voltage.

8. The display device of claim 1, wherein the common touch electrode is disposed under the touch substrate in a substantially planar shape.

9. A touch screen panel, comprising:
a touch substrate;
a touch electrode disposed on the touch substrate and configured to receive a sensing input voltage; and
a common touch electrode disposed under the touch substrate and configured to receive a common input voltage having a phase opposite of the sensing input voltage received by the touch electrode.

10. The touch screen panel of claim 9, further comprising:
an adhesive layer interposed between the common touch electrode and the display panel.

11. The touch screen panel of claim 9, further comprising:
a polarizer disposed above the touch electrode.

12. The touch screen panel of claim 9, wherein a value of parasitic capacitance generated between the touch electrode and the display panel is reduced by the common input voltage.

13. A method for driving a display device, the method comprising:
applying a first voltage to a touch electrode of the display device to detect a touch to a touch screen panel of the display device; and
applying a second voltage having a phase opposite of the first voltage to a common touch electrode of the display device.

14. The driving method of claim 13, wherein the second voltage and the first voltage are applied simultaneously.
